(19) United States
(12) Patent Application Publication
(10) Pub. No.: US 2025/0167713 A1
(43) Pub. Date: May 22, 2025

(54) METHOD FOR CONTROLLING A DRIVE SYSTEM OF A RAIL VEHICLE

(71) Applicant: Siemens Mobility GmbH, München (DE)

(72) Inventors: Christoph Adam, Nürnberg (DE); Johannes Germishuizen, Nürnberg (DE); Olaf Körner, Nürnberg (DE)

(21) Appl. No.: 18/728,941

(22) PCT Filed: Nov. 28, 2022
(86) PCT No.: PCT/EP2022/083391

§ 371 Date: Jul. 15, 2024

(30) Foreign Application Priority Data
Jan. 14, 2022 (DE) 10 2022 200 378.0

(51) Int. Cl. H02P 27/06; H02M 5/458; H02P 25/022

(52) U.S. Cl. CPC H02P 27/06; H02M 5/4585; H02P 25/022

(57) ABSTRACT

A method controls a drive system of a rail vehicle. The drive system contains at least one DC voltage intermediate circuit with at least one intermediate circuit capacitor to which an intermediate circuit voltage is applied during the operation of the drive system, a converter which is connected to the DC voltage intermediate circuit and which contains a plurality of power semiconductor switches, a drive motor which is connected to the converter and which is configured as a three-phase synchronous machine excited by permanent magnets, and a controller for controlling the power semiconductor switches of the converter. The power semiconductor switches are controlled by the controller during a motor operation and a generator operation of the drive motor such that the intermediate circuit voltage is converted into a multiphase AC voltage.

The invention relates to a method for controlling a drive system of a rail vehicle, a corresponding drive system, and a rail vehicle having at least one corresponding drive system.

Drive systems of rail vehicles must fulfill many and varied requirements. In addition to providing reliable operation over a rail vehicle's typical service life of thirty years or more, they are subject to increasingly demanding energy efficiency requirements to reduce the rail vehicle's energy consumption.

In addition to technological advances in the field of rail vehicle drive motor control, for example through the use of silicon carbide (SiC) based power semiconductor switches in the power converters supplying the drive motors, three-phase synchronous machines, particularly permanent magnet excited three-phase synchronous machines, are increasingly being used as drive motors. They achieve a higher efficiency than three-phase asynchronous machines during partial load and full load operation, in particular due to reduced rotor losses, and can therefore be operated more energy-efficiently.

However, the disadvantage compared to an asynchronous machine is that, because of the permanent magnets disposed in the rotor, a permanent magnet excited synchronous machine cannot be completely disengaged in order to be switched in a lossless manner during a coasting phase of the rail vehicle for example, as is possible in the case of asynchronous machines by interrupting the clocking of the supplying converter. A clock lockout, also known as a commutation lockout, in which control of the power semiconductor switches of the supplying power converter is suspended, has the effect of eliminating electromagnetic losses in both the drive motor and the power converter.

Indeed, due to the force-fit connection of the wheelset shaft to the motor shaft, which is typical of rail vehicles, the running of the wheelset and the resulting forced co-rotation of the rotor of the permanent magnet excited synchronous machine during a coasting phase causes the rotating permanent magnet flux to additionally produce eddy current and hysteresis losses. Iron losses, stator copper losses and magnetic losses also occur as a result of current flow from the power converter to the drive motor on the harmonics created by the clocking of the power semiconductor switches of the power converter. Moreover, if a particular voltage is exceeded at the motor terminals, particularly in a coasting phase without drive or braking torque, i.e. when idling, a field-weakening current must be fed from the power converter into the winding of the respective drive motor in order to prevent uncontrolled feedback into the DC link circuit via freewheeling diodes connected in antiparallel with the power semiconductor switches in the power converter.

A coasting phase constitutes one of four movement phases that occur during the operation of a rail vehicle on a line section to be traversed between two stations for example. These four movement phases are subdivided into acceleration, maintaining speed, coasting, and braking/deceleration. The interplay of these phases over the line section is also referred to as the operating cycle. The acceleration phase, which typically follows a stop of the rail vehicle at a station, serves to accelerate the rail vehicle to a desired speed by means of a high tractive effort of the drive system. The drive motors are in motor mode during this phase. In a typically subsequent speed maintaining phase, the tractive effort is reduced to the extent that it corresponds to the train resistance, thereby keeping the attained running speed constant. The drive motors then continue operating in motor mode, but may also be in generator mode, for example when negotiating a downhill section of track. When approaching a station for the next stop, the tractive effort of the drive system is reduced to zero so that the rail vehicle enters a coasting phase in which the running speed is reduced due to the greater train resistance. The drive motors are then in idling mode, in which they generate neither drive nor braking torque. Before the station is reached, the coasting phase then changes to a braking phase in which additional braking forces are used to further reduce the running speed. The additional braking force is preferably produced by operation of the drive motors as generators, also known as regenerative braking, and, if necessary, by applying friction brakes acting on wheelset shafts or wheels. Depending on the topology of the line section to be traversed, the operating cycle of a rail vehicle may also have no speed maintaining or coasting phase.

This is particularly the case with mass transit rail vehicles such as subway trains or metros, where the operating cycle is mainly characterized by acceleration and coasting phases due to short distances between stations, wherein the rail vehicle enters a coasting phase almost immediately after the acceleration phase, for example, and only enters the braking phase when it reaches the station. While a reduction in the energy consumption of the rail vehicle's drive system can be advantageously achieved in the acceleration phase due to the higher efficiency of permanent magnet excited synchronous machines compared to asynchronous machines, this reduction is disadvantageously compensated again in the subsequent coasting phase due to the aforementioned losses and the requirement for active operation of the supplying power converter.

The object of the present invention is therefore to provide a method, a drive system, and a rail vehicle which further increase the energy efficiency of a drive system having permanent magnet excited synchronous machines as drive motors. This object is achieved by the respective features of the independent claims.

A first aspect of the invention relates to a method for controlling a drive system of a rail vehicle, wherein the drive system comprises at least one DC link circuit with at least one DC link capacitor to which a DC link voltage is applied during operation of the drive system, a power converter comprising a plurality of power semiconductor switches which is connected to the DC link circuit, a drive motor connected to the power converter, said drive motor being designed as a permanent magnet excited three-phase synchronous machine, and a control device for controlling the power semiconductor switches of the power converter, wherein, when the drive motor is in motor mode and generator mode, the power semiconductor switches are controlled by the control device such that the DC link voltage is converted into a polyphase AC voltage. In a characterizing manner, during zero-torque idling of the drive motor, control of the power semiconductor switches is suspended depending on a voltage induced in the converter by the drive motor.

According to the invention, when a drive motor designed as a permanent magnet excited synchronous machine is in idling mode, the operation of the power converter in a particular operating phase is therefore suspended in accordance with a clock lockout already implemented for asynchronous machines used as drive motors. On the one hand, this makes it possible to save electrical energy required for operating the power converter and, on the other hand, it is possible to eliminate iron losses, stator copper losses and magnetic losses occurring in the drive motor due to current flowing from the power converter to the drive motor on harmonics during active control, which means that the energy consumption of the drive system and thus its efficiency is advantageously increased.

A clock lockout has hitherto not been implemented for permanent magnet excited synchronous machines as drive motors of a rail vehicle drive system on the grounds that at high rotor speeds or high running speeds of the rail vehicle, the voltage induced at the motor terminals during idling mode and rectified via freewheeling diodes of the power converter can exceed the DC link voltage. A higher induced voltage of this kind has been counteracted in a similar manner to generator operation by means of a field-weakening current, also known as d-current, generated by the power converter through suitable control of the power semiconductors. The field-weakening current is impressed as a negative current in the multiphase stator winding, thereby inducing a back EMF that causes the resulting induced voltage at the motor terminals to be equalized with the DC link voltage, i.e. with a voltage of the fundamental frequency of the power converter.

If the induced voltage exceeds the DC link voltage, a lack of field-weakening current would result in the current generated by the permanent magnet excited synchronous machine being diverted via freewheeling diodes into the DC link circuit, which disadvantageously could lead to losses and unwanted braking torques being generated in the drive system. In addition, a DC link voltage rise enforced by the induced voltage due to the current flowing into the DC link circuit could disadvantageously result in possible damage to semiconductors connected to the DC link circuit.

A field-weakening current is also generated in a particular operating phase of the motor mode and generator mode of the drive motor by suitable control of the power semiconductor switches of the power converter, wherein in this case it is used to enable the motor speed in the field-weakening range to be increased beyond the rated speed of the permanent magnet excited synchronous machine at constant power but decreasing torque, wherein a maximum voltage is present at rated motor speed and wherein the synchronous machine generates a maximum torque up to the rated motor speed.

In order to be able to generate a field-weakening current even during idling of the drive motor, the power semiconductor switches of the power converter have hitherto been controlled continuously by the control device, i.e. also throughout idling mode of the drive motor. According to the invention, however, it was recognized that in certain operating phases during idling, it is possible to suspend control of the power semiconductor switches without the risk of a forced increase in the DC link voltage with the disadvantageous consequences described above. The possibility of suspending control is present in particular during a coasting phase of the rail vehicle in which, as described in the introduction, the tractive effort of the drive system is reduced to zero by the vehicle driver or rather by the traction system, so that the speed of the rail vehicle is successively reduced due to the then greater train resistance. If, in such a coasting phase, the speed of the rail vehicle corresponds to an induced voltage of the drive motor that is lower than the DC link voltage, control of the power semiconductor switches of the power converter can be suspended, especially as the speed of the rail vehicle and, correspondingly, the induced voltage will not subsequently increase again. Knowledge of the voltage induced in the converter by the drive motor during idling is essential for deciding whether control of the power semiconductor switches can be suspended.

According to a development of the method, the voltage induced in the power converter by the drive motor is determined on the basis of at least one operating variable of the drive motor, wherein the operating variable comprises a motor speed and/or a current fed to the power converter or is representative thereof.

To determine the voltage induced by the drive motor, it is advantageous to use operating variables of the drive motor that have already been taken into account for determining the required field-weakening current. Thus, there is a known relationship between the motor speed, which is detected by means of a speed sensor on the motor shaft or can also be derived from a detected rotational speed of the wheelset shaft driven by the drive motor, and the induced voltage of the drive motor, so that a voltage currently being induced can be determined in the control device from the detected or inferred motor speed. Alternatively or in addition, currents can be detected in phases of the stator winding or more specifically in motor cables connecting the stator winding to the converter, from which phases the induced voltage can in turn be determined by the control device. In the case of a three-phase stator winding, for example, it is sufficient to detect the respective current in one phase or in two phases.

According to another development of the method, the voltage induced in the converter by the drive motor is compared with a threshold value by the control device, wherein the threshold value is defined as a function of the DC link voltage.

The threshold value is preferably defined as a voltage value that is lower than the DC link voltage. The control device compares the determined induced voltage of the drive motor with a threshold value defined in this way and, if the value is below the threshold value, control of the power semiconductor switches of the power converter is suspended or a clock lockout of the power converter is implemented. For example, a moving average of the induced voltage determined can be compared with the threshold value, thereby increasing the certainty that the induced voltage is actually lower than the DC link voltage. Alternatively or in addition, the threshold value can also have a particular negative voltage difference, in percentage or absolute terms, with respect to the DC link voltage.

If the drive system of the rail vehicle is supplied with electrical energy from a traction power supply network, in particular a DC traction power supply network, for example by means of an overhead line or third rail, voltage level fluctuations occurring in the traction power supply network result in corresponding fluctuations in the DC link voltage. The threshold value is preferably defined on the basis of a present DC link voltage; alternatively, however, the threshold value can also be defined such that a highest DC link voltage occurring during such fluctuations is taken into account for defining the threshold value.

According to another development of the method, control of the power semiconductor switches of the power converter by the control device is additionally suspended contingent upon a movement phase of the rail vehicle.

As explained in the introduction, the advantage of additionally taking the movement phases into account is that power semiconductor control can, for example, be suspended exclusively during a coasting phase of the rail vehicle, i.e. only if neither tractive force nor braking force is requested by the vehicle driver or rather the drive control system. On the other hand, a clock lockout of the power converter should not be implemented during a braking phase, for example, in which the drive motor is in generator mode and the energy generated is to be used for regenerative braking of the rail vehicle. At a transition from a coasting phase, in which control of the power semiconductor switches is suspended, to a braking phase, for example due to a braking request by the vehicle driver or drive control system, the clock lockout of the power converter is lifted again.

A second aspect of the invention relates to a drive system of a rail vehicle, wherein the drive system comprises at least one DC link circuit comprising at least one DC link capacitor to which a DC link voltage is applied during operation of the drive system, a power converter connected to the DC link circuit and comprising a plurality of power semiconductor switches, a drive motor connected to the power converter, said drive motor being designed as a permanent magnet excited three-phase synchronous machine, and a control device for controlling the power semiconductor switches of the power converter, wherein, when the drive motor is in motor mode and in generator mode, the power semiconductor switches are controlled by the control device in such a way that the DC link voltage is converted into a polyphase AC voltage. In a characterizing manner, depending on a voltage induced in the converter by the drive motor, the control device is designed to suspend control of the power semiconductor switches when the drive motor is in zero-torque idling mode.

The at least one DC link capacitor of the DC link circuit can be designed as a single capacitor, but alternatively also as a plurality of capacitors disposed in particular in a distributed manner and assigned to a respective power semiconductor switch of the power converter. The power converter supplying the at least one stator winding of the drive motor is preferably designed as a pulse controlled inverter which converts a DC voltage provided by the DC link circuit into a multiphase, in particular three-phase, AC voltage of variable voltage level and frequency.

According to another development of the drive system, the drive motor is designed to use at least one means within the motor to reduce a voltage induced during idling.

Such means within the motor that advantageously enable control of the power semiconductors to be suspended earlier due to a lower induced voltage include for example reducing the turn count of the coils and/or connecting turns or coil groups of the stator winding in parallel. Alternatively or in addition, reducing the permanent magnet fields in the rotor of the drive motor is also desirable. This can be achieved in particular by means of a deeper, in particular V-shaped arrangement of the permanent magnets when viewed in the radial direction of the laminated rotor core, which increases the contribution of core reluctance to torque generation.

According to another development of the drive system, the power semiconductor switches are implemented on the basis of a semiconductor material having a larger band gap than silicon, in particular based on silicon carbide, gallium nitride or diamond.

Power semiconductor switches based on silicon carbide (SiC), gallium nitride (GaN) or diamond allow in particular a higher clock frequency of the power converter. Higher clocking rates can be used to reduce current and voltage harmonics that can occur due, in particular, to the above-mentioned means employed. Specifically, reducing the number of turns of the stator winding results in a lower inductance and therefore to increased losses and noise in the drive motor. A higher clock frequency is possible both when generating a synchronous pulse pattern in a low motor speed or running speed range and when generating a synchronous pulse pattern in a higher motor speed or running speed range of the rail vehicle.

A third aspect of the invention relates to a rail vehicle comprising at least one drive system according to the invention.

Such a rail vehicle is designed in particular as a multiple-unit train for local, regional or long-distance transportation, but it can be designed in the same way as a locomotive.

Finally, a fourth aspect of the invention relates to the use of a drive system according to the invention in a rail vehicle.

The invention will now be explained with reference to exemplary embodiments, in respect of which:

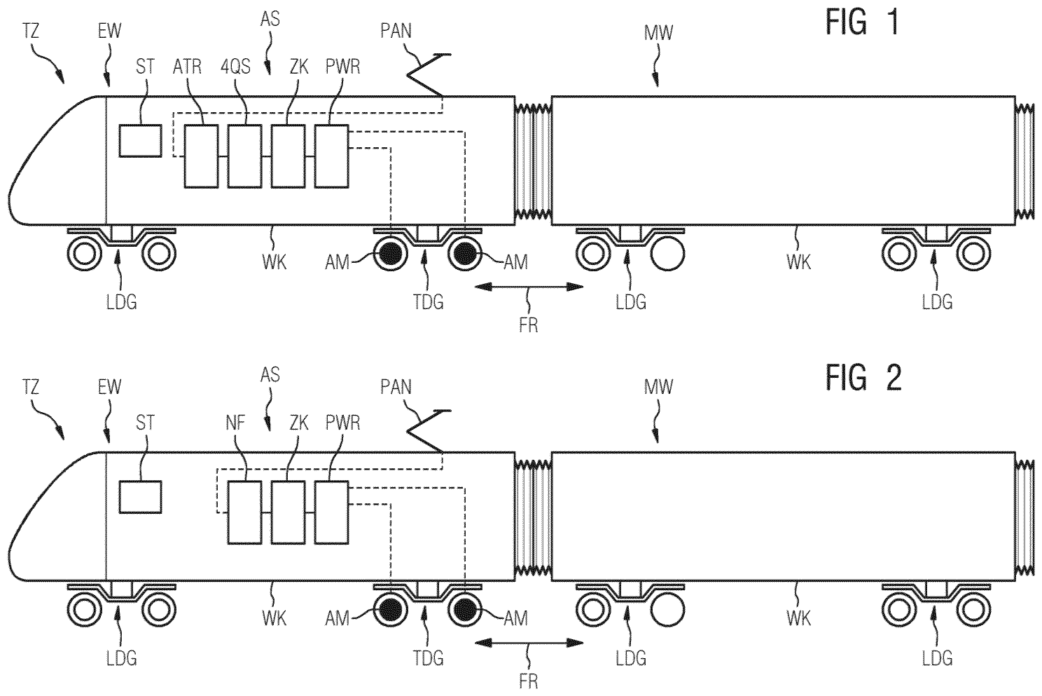

FIG. 1 shows a rail vehicle with a drive system for operation on an AC traction power supply network,

FIG. 2 shows a rail vehicle with a drive system for operation on a DC traction power supply network,

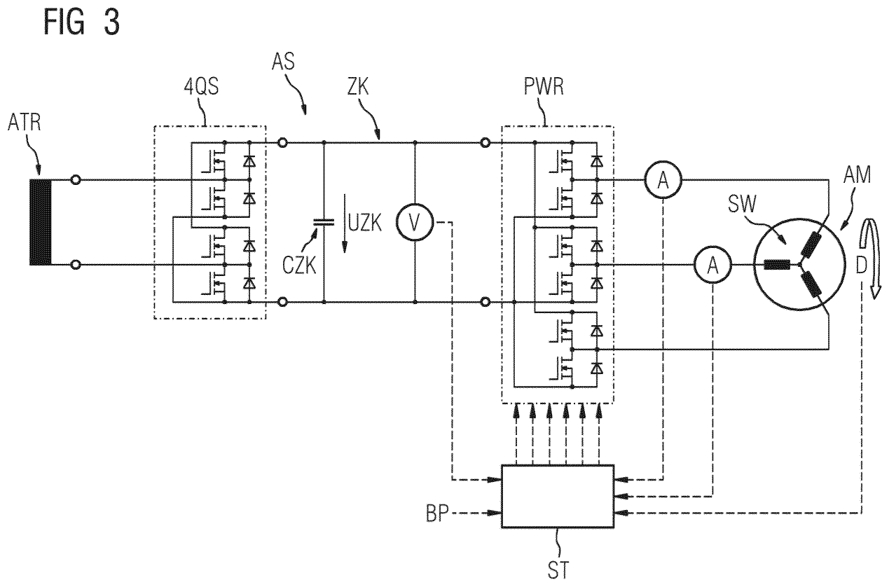

FIG. 3 shows a drive system for operation on an AC traction power supply network,

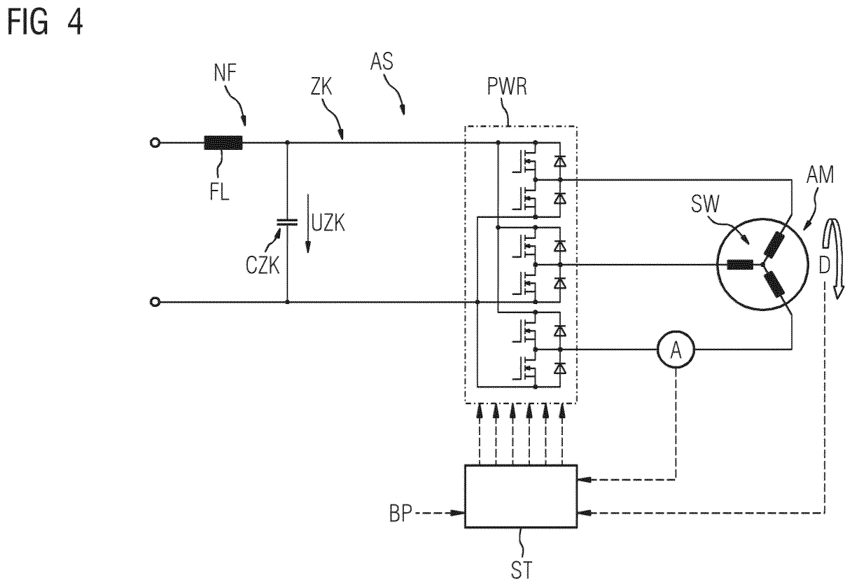

FIG. 4 shows a drive system for operation on a DC traction power supply network, and

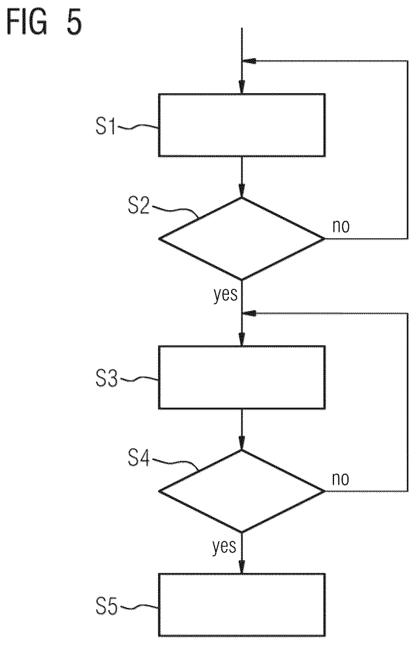

FIG. 5 shows flow chart of a method.

For reasons of clarity, the same reference characters are used in the figures for components that are identical or have the same or almost the same effect.

FIG. 1 shows a schematic side view of a rail vehicle TZ. By way of example, the rail vehicle TZ is designed as a multiple unit for passenger transport and comprises a plurality of cars, wherein only an end car EW and a middle car MW coupled to it are shown. Both cars have a respective car body WK which is supported by wheel trucks in the form of a motored truck TDG with drive motors AM or unmotored trucks LDG without traction motors disposed therein on rails of a track (not shown). The rail vehicle TZ moves on the rails in the directions of travel FR determined thereby.

In the end car EW, components of a drive system AS of a rail vehicle operated from an AC traction power supply network are indicated schematically. These are usually disposed in special areas within the car body, in the underfloor area, in the roof area or also distributed over a plurality of cars of the rail vehicle TZ.

Further components of the traction equipment, for example a traction battery, as well as auxiliary systems required for the operation of the components are also provided, but are not specifically shown in FIG. 1.

The traction equipment AS can be electrically connected to an overhead line (not shown) of the AC traction power supply network via a pantograph PAN disposed for example in the roof area of the end car EW, wherein the overhead line carries, for example, a single-phase alternating current. On the supply side, the alternating current is fed to a primary winding of a drive transformer ATR in which the voltage level on the supply side is transformed down for example from 15 kV or 25 kV to a lower voltage level. A secondary winding of the drive transformer ATR is connected to a supply-side converter 4QS, for example a four-quadrant converter, which rectifies the alternating current.

The supply-side power converter 4QS supplies a DC link circuit ZK, which in turn supplies a load-side power converter PWR, for example a pulse inverter. One or more DC link capacitors are disposed in the DC link circuit and are used as electrical energy storage devices, in particular for smoothing the DC voltage. An additional series resonant circuit is not specifically shown. From the DC voltage, the load-side power converter PWR generates, for example, a three-phase AC voltage of variable frequency and amplitude which is used to supply the stator windings of two drive motors TM disposed in the motored truck TDG of the end car EW. The operation of the supply-side 4QS and the load-side power converter PWR in particular is controlled in a known manner by a control device ST of the drive system AS.

FIG. 2 schematically illustrates the rail vehicle TZ of FIG. 1 with an alternative drive system AS. In this example, the pantograph PAN can be connected to an overhead line (again not shown) of a DC traction power supply network. Instead of an overhead contact line, a conductor rail is often run parallel to the track, particularly in the mass transit sector, to which the drive system AS can be connected via one or more lateral contact shoes mounted for example in the region of the car body ends or trucks. The direct current of the traction power supply network is fed via an input filter or line filter NF to the DC link circuit ZK of the drive system AS, said line filter NF comprising for example a filter inductor in the form of a choke, and a capacitor, wherein the capacitor can also act as a DC link capacitor of the drive system AS.

FIG. 3 schematically illustrates the drive system AS of the rail vehicle TZ of FIG. 1, wherein not all the components of the drive system AS are shown. For example, only a secondary winding of the drive transformer ATR fed by an AC traction power supply network and only one drive motor AM are shown.

In the drive system AS, the secondary winding of the drive transformer ATR is connected to the supply-side power converter 4QS. The supply-side power converter 4QS is designed as a four-quadrant converter which converts the AC voltage provided on the input side by the drive transformer ATR into a DC voltage and provides it on the output side. The conversion is performed by means of power semiconductor switches or power transistors which are based for example on semiconductors having a larger band gap than silicon, in particular silicon carbide (SiC), gallium nitride (GaN) or diamond. Two power transistors in each case are electrically connected in series in a switching branch, the connection point of which is connected to a respective input of the supply-side power converter 4QS, wherein a parallel switching branch or a whole-number multiple of parallel switching branches is/are provided for each output.

Electrical energy that is generated when the drive motors AM are in generator mode can be fed back into the DC link circuit and, if necessary, on into the traction power supply network via additional power diodes connected in antiparallel with the respective power transistors. In the case of a three-phase stator winding of the drive motor, for example, the freewheeling diodes rectify the phase currents similarly to an uncontrolled three-phase bridge, also known as a B6U. The rectified current flows into the DC link capacitor, the charging and discharging of which, viewed over a complete period, does not generate any active power, so that the current does not need to be removed via a braking controller connected to the DC link circuit, for example. Alternatively, the power semiconductor elements, in particular MOSFETs (metal oxide semiconductor field effect transistors) based on silicon carbide (SIC) can have an internal so-called body diode so that no additional anti-parallel connected power diode is required. Power semiconductor elements are usually disposed in modules that are attached to a heat sink made of an aluminum material, for example, in order to dissipate heat losses that occur during operation of the power converter.

Via the outputs, the supply-side power converter 4QS feeds a DC link circuit ZK in which a DC link capacitor CZK is disposed, wherein alternatively a plurality of DC link capacitors CZK can also be electrically connected in parallel in order to provide a desired capacitance. A DC link voltage UZK is dropped across the DC link capacitor CZK. Suitable control of the power semiconductor switches in the supply-side converter 4QS by the control device ST has the objective of keeping the voltage value of the DC link voltage UZK largely independent of a fluctuating voltage value of the traction power supply network, wherein a series resonant circuit (not specifically shown) in the DC link circuit ZK, comprising an inductance and a capacitance, is normally used to absorb a fundamental frequency power pulsation of the supply network.

The load-side power converter PWR is connected to the DC link circuit ZK and is designed as a pulse inverter which converts the DC voltage present on the input side into an AC voltage of variable voltage level and frequency, and provides it on the output side. The conversion is again carried out by means of power semiconductor switches or power transistors which are preferably based on semiconductors having a larger band gap than silicon, in particular silicon carbide (SiC), gallium nitride (GaN) or diamond. In contrast to the supply-side power converter 4QS, the load-side power converter PWR has three or a whole-number multiple of three parallel switching branches, each comprising two power transistors connected in series, for example for the three phases of the stator winding of the drive motor AM. In the case of a pulse inverter with four-quadrant operation, it is again inherently possible for electrical energy generated by the drive motor AM operating in generator mode to be fed back.

The drive motor AM supplied by the load-side power converter PWR is designed as a permanent magnet excited three-phase synchronous machine, wherein the stator winding SW is optimized for example in respect of having a low number of turns in the stator, and the rotor's laminated core is optimized in respect of having a higher reluctance component compared to the permanent magnets disposed therein.

The control device ST controls the six power semiconductor switches in the load-side converter PWR, as indicated by six vertical dashed arrows emanating from the control device ST. In the same way, the control device ST also controls the power semiconductor switches of the supply-side power converter 4QS in the manner described above, but this is not specifically shown in FIG. 3. By way of example, the control device ST is supplied with various signals or information, on the basis of which it makes a decision as to whether to suspend control of the power semiconductor switches of the load-side power converter PWR.

The signals or information supplied to the control device ST comprise or represent, in particular, a DC link voltage UZK, which is determined for example by means of a voltmeter V disposed in the DC link circuit ZK in parallel with the DC link capacitor ZK, a movement phase BP, which can be inferred for example from a tractive effort or braking force request on the part of the vehicle driver or a vehicle control system, a speed D of the drive motor AM, which is determined for example by means of a motor speed sensor on the shaft of the drive motor AM, and currents in the phases of the stator winding SW of the drive motor AM, which are determined for example by means of ammeters A disposed in or on motor cables.

FIG. 4 schematically illustrates the drive system AS of the rail vehicle TZ of FIG. 2, wherein again not all components of the drive system AS are shown. The drive system AS is designed to be connected to a DC traction power supply network via a current collector, wherein the direct current is fed to the load-side power converter PWR for example via an input filter or line filter NF consisting of a filter inductor FL in the form of a choke and the DC link capacitor CZK. Together with the DC link capacitor CZK, the filter inductance FL creates a series resonant circuit which is tuned to the frequencies of the parasitic currents to be filtered. The load-side power converter PWR is again designed as a pulse inverter which converts the input-side DC voltage of the DC link circuit ZK into a three-phase AC voltage of variable voltage level and frequency with which the three phases of the stator winding SW of the drive motor AM are supplied.

As shown in FIG. 3, the control device ST controls the six power semiconductor switches in the power converter PWR. Depending on the signals or information supplied to it with regard to an operating phase of the drive system AS, a speed of the motor shaft, a current flow in a phase of the stator winding SW and, where applicable, a DC link voltage UZK, the control device ST in turn makes a decision about suspending control of the power semiconductor switches of the power converter PWR.

Lastly, FIG. 5 shows a flow chart of an exemplary method which is carried out in the control device ST for deciding whether to suspend control of the power semiconductor switches of the load-side power converter PWR. In a first step S1, the movement phase BP in which the rail vehicle is currently operating is determined. This can be inferred in particular from tractive effort or braking force requests. In a second step S2, it is checked whether the movement phase determined is a coasting phase. If this is not the case (no branch), but the movement phase is, for example, an acceleration, speed maintaining or braking phase, the method reverts to the first step S1. If the movement phase determined is a coasting phase (yes branch), a voltage induced by the drive motor in the load-side converter is determined in a subsequent third step S3 from signals or information supplied to the control device as described above. In a fourth step S4, the induced voltage determined is compared with a voltage threshold value, wherein the threshold value is defined, for example, as a function of the DC link voltage and, in particular, as a function of a value of a highest possible DC link voltage due to fluctuations in the supply voltage. If the particular induced voltage exceeds the threshold value or corresponds to it (no branch), the method reverts to the third step S3 or, in an alternative embodiment of the method, to the first step S1. If, on the other hand, the induced voltage determined is below the threshold value, i.e. the induced voltage is lower than the DC link voltage (yes branch), the control device suspends control of the power semiconductor switches of the supply-side power converter, corresponding to a clock lockout.

1-9. (canceled)

10. A method for controlling a drive system of a rail vehicle, the drive system containing:
a DC link circuit with at least one DC link capacitor at which a DC link voltage is present during operation of the drive system;
a power converter connected to the DC link circuit and having a plurality of power semiconductor switches;
a drive motor connected to the power converter and configured as a permanent magnet excited three-phase synchronous machine;
a controller for controlling the power semiconductor switches of the power converter;
wherein the method comprises the steps of:
controlling the power semiconductor switches by the controller such that the DC link voltage is converted into a polyphase AC voltage when the drive motor is in a motor mode and in a generator mode; and
suspending control of the power semiconductor switches depending on a voltage induced in the power converter by the drive motor when the drive motor is in a zero-torque idling mode.

11. The method according to claim 10, which further comprises determining the voltage induced in the power converter by the drive motor on a basis of at least one operating variable of the drive motor, wherein the at least one operating variable includes a motor speed and/or a current fed into the power converter or is representative thereof.

12. The method according to claim 10, which further comprises using the controller to compare the voltage induced in the power converter by the drive motor with a threshold value, wherein the threshold value is defined in dependence on the DC link voltage.

13. The method according to claim 10, which further comprises additionally suspending the control of the power semiconductor switches of the power converter by the controller in dependence on a movement phase of the rail vehicle.

14. A drive system of a rail vehicle, the drive system comprising:
a DC link circuit having at least one DC link capacitor at which a DC link voltage is present during operation of the drive system;
a power converter connected to said DC link circuit and containing a plurality of power semiconductor switches;
a drive motor connected to said power converter and configured as a permanent magnet excited three-phase synchronous machine;
a controller for controlling said power semiconductor switches of said power converter, wherein, when said drive motor is in a motor mode and a generator mode, said power semiconductor switches are controlled by said controller such that the DC link voltage is converted into a polyphase AC voltage; and
when said drive motor is in a zero-torque idling mode, said controller being configured to suspend control of said power semiconductor switches depending on a voltage induced in said power converter by said drive motor.

15. The drive system according to claim 14, wherein said drive motor is configured to reduce the voltage induced during the zero-torque idling mode using at least one means within said drive motor.

16. The drive system according to claim 14, wherein said power semiconductor switches are based on a semiconductor material having a larger band gap than silicon.

17. The drive system according to claim 16, wherein said semiconductor material is selected from the group consisting of silicon carbide, gallium nitride and diamond.

18. A rail vehicle, comprising:
at least one said drive system, containing:
a DC link circuit having at least one DC link capacitor at which a DC link voltage is present during operation of said at least one drive system;
a power converter connected to said DC link and containing a plurality of power semiconductor switches;
a drive motor connected to said power converter and configured as a permanent magnet excited three-phase synchronous machine;
a controller for controlling said power semiconductor switches of said power converter, wherein, when said drive motor is in a motor mode and a generator mode, said power semiconductor switches are controlled by said controller such that the DC link voltage is converted into a polyphase AC voltage; and
when said drive motor is in a zero-torque idling mode, said controller being configured to suspend control of said power semiconductor switches depending on a voltage induced in said power converter by said drive motor.

19. A method of using a drive system, which comprises the steps of:
installing the drive system according to claim 14 in a rail vehicle; and
operating the rail vehicle using the drive system.
